(19) United States
(12) Patent Application Publication
(10) Pub. No.: US 2015/0052432 A1
(43) Pub. Date: Feb. 19, 2015

(54) ELECTRONIC DEVICE AND CONTROL METHOD

(71) Applicant: Acer Incorporated, New Taipei City (TW)

(72) Inventors: Chih-Feng Hsu, New Taipei City (TW); Shau-Yang Hsieh, New Taipei City (TW); Shih-Yang Wang, New Taipei City (TW); Chi-Jen Chen, New Taipei City (TW); Tzu-Ching Lin, New Taipei City (TW); Nan-Kuang Chen, New Taipei City (TW); Kuang-Rong Lu, New Taipei City (TW)

(73) Assignee: Acer Incorporated, New Taipei City (TW)

(21) Appl. No.: 14/084,154

(22) Filed: Nov. 19, 2013

(30) Foreign Application Priority Data
Aug. 16, 2013 (TW) 102129420

(51) Int. Cl. G06F 3/16; G06F 17/24

(52) U.S. Cl. CPC G06F 3/165; G06F 17/241
USPC 715/716

(57) ABSTRACT

An electrical device includes an input device, an application recorder and a control unit. The input unit is configured to receive a first enabling signal at a first time and a second enabling signal at a second time, respectively. The application recorder is configured to record the plurality of applications which have been executed by the electrical device. At the first time, the first application is the latest-executed among the plurality of applications. The control unit obtains a first metadata of a first application from the application recorder and links a first memo data input by the user to the first metadata. At the second time, the second application is the latest-executed among the plurality of applications. The control unit obtains a second metadata of a second application and links a second memo data input by the user to the second application.

### CROSS REFERENCE TO RELATED APPLICATIONS

This Application program claims priority of Taiwan Patent Application program No. 102129420, filed on Aug. 16, 2013, the entirety of which is incorporated by reference herein.

### BACKGROUND OF THE INVENTION

1. Field of the Invention

The invention relates to an electronic device, and in particular to an electronic device capable of recording and restoring to a control status.

2. Description of the Related Art

As mobile electronic devices have become widely used, the user uses them to perform some operations more commonly, such as browsing the web, listening to music or playing games. When the user browses the web via the browser and wants to store the viewed pages, the user usually records the web pages with a record function provided by the browser itself. Or, while playing music with a music player, the user records the played music with a record function provided by the music player itself. Then, the user can restore the previous operation status using the stored records. For example, some browsers can record a website so that the user can restore to the viewed website the next time (the browser is activated), or some music players can record the song which is playing for the user to replay the song the next time (he activates the music player).

Although some application programs are equipped with a recording function, the user needs to respectively start the different records corresponding to the application programs in order to restore the controlled status of each. Hence, it is really inconvenient for the user. Furthermore, the recording function provided by the current application programs cannot help the user annotate. If there are plenty of records, the user may become confused as to the content of the records. Therefore, an electronic device and a control method is need.

### BRIEF SUMMARY OF THE INVENTION

A detailed description is given in the following embodiments with reference to the accompanying drawings.

The present invention discloses an electronic device. The electronic device includes an input device, configured to receive a first enabling signal at a first time and receive a second enabling signal at a second time, wherein the first time is different from the second time; an application program recorder, configured to record a plurality of application programs performed by the electronic device; a control unit, configured to obtain the last-performed first related data of a first application program in the application program via the application program recorder at the first time and to connect a first memo data input by the user to a first related data and to obtain the last-performed second related data of the second application program in the application program via the application program recorder at the second time and to connect the second memo data input by the user to the second related data, wherein the first application program is different from the second application program.

The present invention discloses a control method. A control method is applicable for an electronic device having an input device, an application program recorder and a control unit. The control method includes reading the last-performed first related data of the first application program in the application program recorder at the first time while receiving the first enabling signal of the input device at the first time and connecting the first memo data input by the user to the first related data and reading the last-performed second related data of the second application program in the application program recorder at the second time and connecting a second memo data input by the user to the second related data, wherein the first time is different from the second time as well as the first application program is different from the second application program.

### BRIEF DESCRIPTION OF THE DRAWINGS

The present invention can be more fully understood by reading the subsequent detailed description and examples with references made to the accompanying drawings, wherein:

FIG. 1 is schematic diagram of the electrical device according to an embodiment of the disclosure;

FIG. 2 is control method according to an embodiment of the disclosure;

FIG. 3 is another control method according to an embodiment of the disclosure;

FIGS. 4A-4B are control method according to an embodiment of the disclosure; and

FIG. 5 is control method according to an embodiment of the disclosure.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

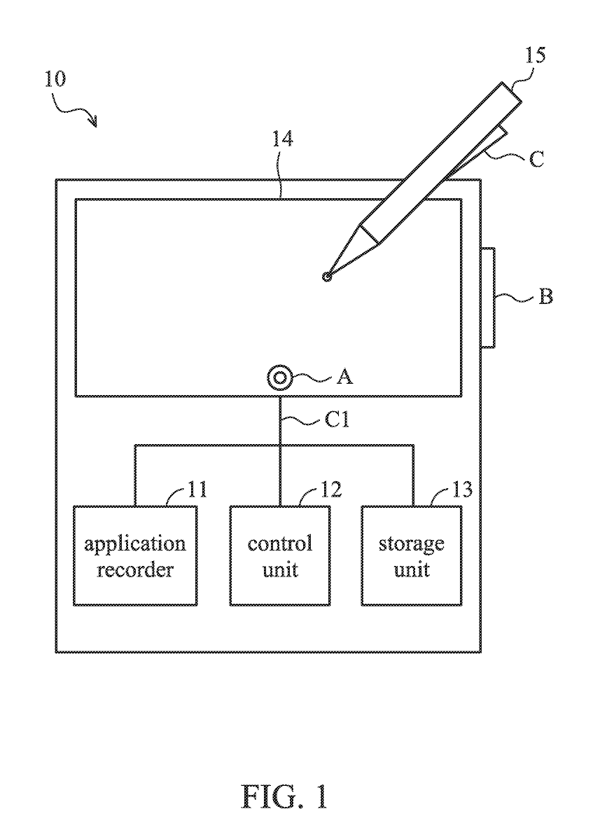

FIG. 1 is a schematic diagram of an electronic device according to one embodiment of the present invention. As shown in FIG. 1, the electronic device 10 includes an application recorder 11, a control unit 12, a storage unit 13, a display 14 and an input device. For example, the electronic device 10 can be a handheld mobile device, a smartphone or a tablet PC, but it is not limited thereto. In one embodiment, the application recorder 11, the control unit 12, the storage unit 13, the display 14 and the input device B in the electronic device 10 are connected by the bus C1.

In the present embodiment, the application recorder 11 is configured to record the plurality of applications performed by the electronic device 10. In one embodiment, when the electronic device 10 stops performing an application, the application recorder 11 removes the corresponded record of the application. In one embodiment, when an application is performed, the application recorder 11 records related data of the application. For example, the related data includes an application name and an execution path, but it is not limited thereto. In an embodiment, the application recorder 11 in the way of stack to record the order of the application performed by the electronic device 10, but it is not limited thereto. For example, the application recorder 11 places the data corresponding to the last-performed (or currently performed) applications to the top of the recorded data according to the order of the applications performed and places the data corresponding to the earliest performed application to the button of the recorded data. In one embodiment, the last-performed (or being currently performed) application is the application displayed on the display 14.

In one embodiment, the control unit 12 obtains the application name and the execution path of the last-performed applications by reading the recorded data of the application recorder 11, but it is not limited thereto. In one embodiment, the application recorder 11 further records the performed time of the application, but it is not limited thereto.

The control unit 12 can be a general-purpose processor, an application processor, a digital signal processor (DSP), or a micro control unit (MCU), but it is not limited thereto. The storage unit 13 can be a volatile memory (e.g. random access memory), a non-volatile memory (e.g. flash memory), hard disks, CD-ROM, or any combination of these media for storing data, code or instruction sets. In one embodiment, the application recorder 11 can be implemented by either an application or the operation system executed by the control unit 12, but it is not limited thereto.

The display 14 can be a computer screen, a smartphone screen, a tablet PC screen, a TV screen or a mobile phone screen, but it is not limited thereto. In one embodiment, the display 14 is a touch panel, not only to display the image, but also to receive a touch signal with the touch function, but it is not limited thereto.

In this embodiment, the electronic device 10 receives the enabling signal by the input device. The input device can be a physical (hardware) input device, or an input device implemented by the software displayed on the display 14, but it is not limited thereto. For example, the input device B can be the hardware button on the electronic device 10. When the user presses the input device B, the input device B receives the input-enabling signal input by the user. In another embodiment, the input device C can be a hardware button on the touch pen. When the user presses the input device C on a touch pen, the input device C receives the enabling signal input by the user. In another embodiment, the display 14 is a touch panel, and the input device A is the software button displayed on the display 14. When the user presses the input device A displayed on the display 14, the input device A receives the enabling signal input by the user. The electronic device 10 has different input devices A, B and C at the same time, or has only one input device A, B or C, but it is not limited thereto.

In the present embodiment, when the input device A (or B, or C) receives a first enabling signal at a first time, the first enabling signal is transmitted to the control unit 12 via the bus C1. When the control unit 12 receives the first enabling signal, the control unit 12 obtains the first related data of the first application which is the last application performed before the first time (or the first application displayed by the display 14 at the first time). Furthermore, the control unit 12 also shows a text input window displayed on the display 14 for receiving the first memo data input by the user. When the electronic device 10 receives the first memo data, the first memo data is transmitted to the control unit 12 via the bus C1. The control unit 12 links the first memo data to the first related data of the first application. For example, the control unit 12 links the first memo data to the application name and the execution path of the first application, but it is not limited thereto.

In another embodiment, when the control unit 12 receives the first enabling signal, the control unit 12 further records the first image displayed on the display 14 at the first time. In the present embodiment, the control unit 12 stores the first record formed by the first image and the first memo data to the storage unit 13. For example, the first record includes the first image and the first memo data, and the first memo data is linked to the execution path and the application name of the first application, but it is not limited thereto. In one embodiment, when the first application is a browser, the first image is an image displayed on the display 14 at the first time, and the first memo data is linked to the application name and the execution path of the browser.

Similarly, when the input device A (or B, or C) receives a second enabling signal at a second time, the second enabling signal is transmitted to the control unit 12 via the bus C1. In addition, when the control unit 12 receives the second enabling signal, the control unit 12 obtains the second related data of the second application which is the last application performed before the second time (or the second application displayed by the display 14 at the second time). Furthermore, the control unit 12 also shows the text input window displayed on the display 14 for receiving the second memo data input by the user. When the electronic device 10 receives the second memo data, the second memo data is transmitted to the control unit 12 via the bus C1. The control unit 12 links the second memo data to the second related data of the second application. For example, the control unit 12 links the second memo data to the application name and the execution path of the second application, but it is not limited thereto.

In the present embodiment, when the control unit 12 receives the second enabling signal, the control unit 12 further records the second image displayed on the display 14 at the second time. In the present embodiment, the control unit 12 stores the second record formed by the second image and the second memo data to the storage unit 13. For example, the second record includes the second image and the second memo data, and the second memo data is linked to the execution path and the application name of the second application, but it is not limited thereto. In one embodiment, when the second application is a music player, the second image is the image displayed on the display 14 at the second time, and the second memo data is linked to the application name and the execution path of the music player.

It should be noted, that in the present embodiment, the first time is different from the second time, and the first application is also different from the second application. In another embodiment, the first application can be the same as the second application, but it is not limited thereto. The first application or the second application can be a browser, a music player, an e-book software, an office software (such as word or excel) or a game software, but it is not limited thereto.

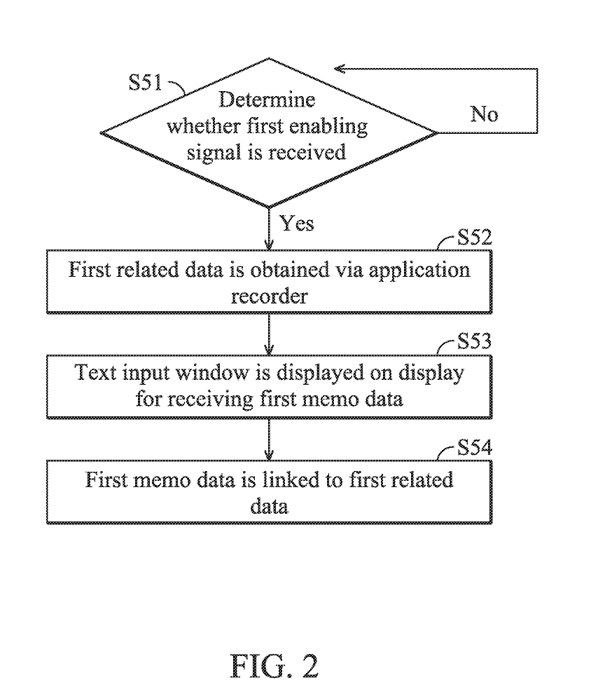

FIG. 2 is a flowchart of the control method according to an embodiment of the present invention. FIG. 2 illustrates the control method of the electronic device 10 when the input device A (or B, C) receives the enabling signal at the first time. The process begins in step S51, and the control unit 12 determines whether it receives the first enabling signal from the input device A (or B, C). When the control unit 12 receives the first enabling signal, the process goes to step S52. When the control unit 12 does not receive the first enabling signal, the process goes back to step S51. For example, when the user presses (or touches) the software button displayed on the display 14, the hardware button on the electronic device 10 or the touch pen 15, the control unit 12 receives the first enabling signal.

In step S52, the control unit 12 obtains the first related data via the application recorder 11, and the process goes to step S53. For example, when the control unit 12 receives the first enabling signal, the control unit 12 obtains the first related data of the last-performed first application from the application recorder 11. In the step S53, the control unit 12 displays the text input window on the display 14 for receiving the first memo data, and the process goes to step S54. For example, the control unit 12 displays the text input window on the display 14 and receives the first memo data input by the user. In one embodiment, the user inputs the first memo data via the display 14 having a touch-sensitive function, a keyboard, a mouse or the touch pen 15, but it is not limited thereto.

In the step S54, the control unit 12 links the first memo data to the first related data. For example, the first memo data links to the application name and the execution path of the first application. Moreover, when the input device A (or B, C) receives the second enabling signal at the second time, the control method of the electronic device 10 at the second time is similar to steps S51-S54 shown in FIG. 2. For the operations of the electronic device 10 at the second time, please refer to FIG. 2, as the details thereof are omitted here for brevity.

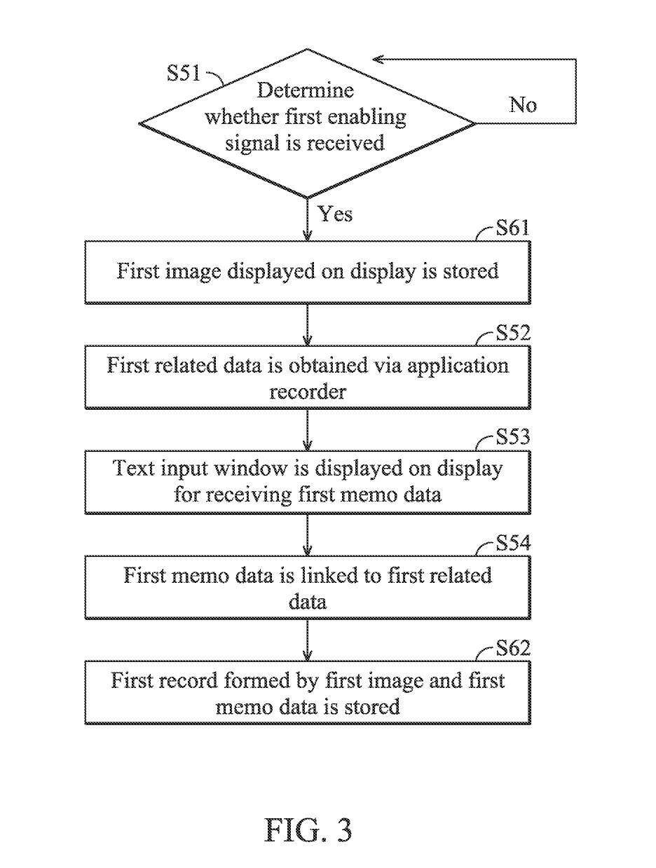

FIG. 3 is another flow chart of the control method according to an embodiment of the present invention. FIG. 3 illustrates the control method of the electronic device 10 when the input device A (or B, C) receives the first enabling signal at the first time. Steps S51-S54 in FIG. 3 are similar to steps S51-S54 in FIG. 2, and the difference is that FIG. 3 further includes step S61 and step S62. The control method of steps S51-S54, please refer to FIG. 2, as the details thereof are omitted here for brevity. In step S61, the control unit 12 stores the first image displayed on the display 14. In one embodiment, the first image is an image of the first application displayed on the display 14 at the first time.

In step S62, the control unit 12 stores the first record formed by the first image and the first memo data to the storage unit 13. For example, the first record includes the first image and the first memo data, but it is not limited thereto. Additionally, when the input device A (or B, C) receives the second enabling signal at a second time, the control method of the electronic device 10 is similar to steps S51-S54 and the steps S61-S62, and thus, the operations of the electronic device 10 at the second time please refer to FIG. 3, and thus the details thereof are omitted for brevity.

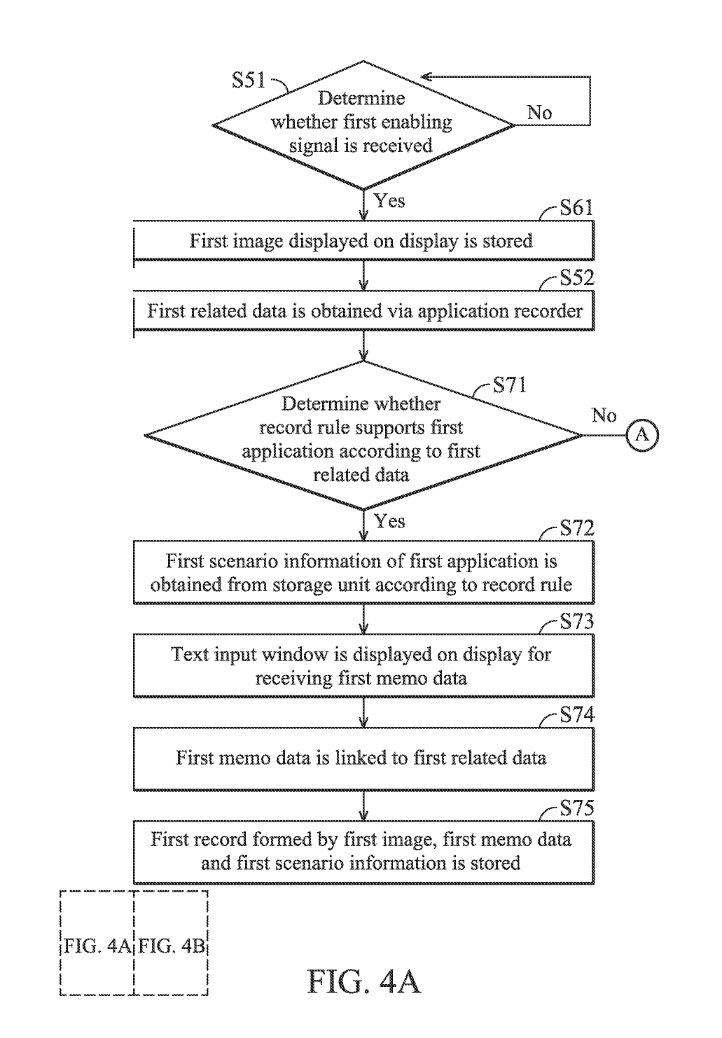

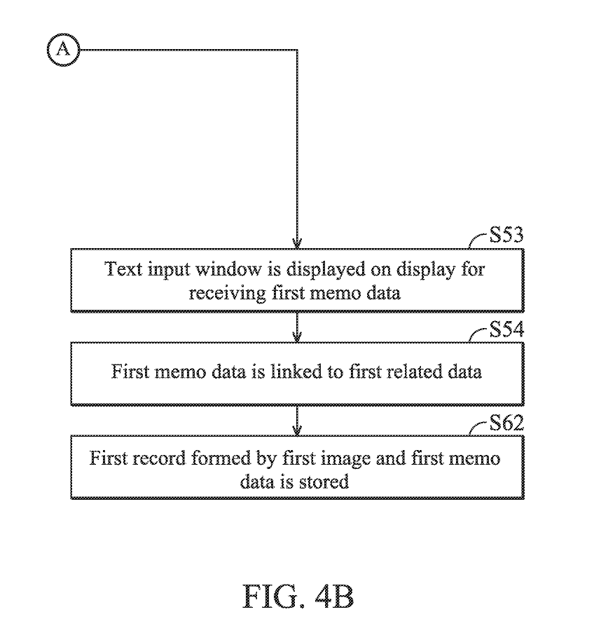

FIGS. 4A-4B are another flow chart of the control method according to an embodiment of the present invention. FIGS. 4A-4B illustrate the control method of the electronic device 10 when the input device A (or B, C) receives the first enabling signal at the first time. The steps S51-S54 in FIGS. 4A-4B are similar to steps S61-S62 in FIG. 3, and the difference is that FIGS. 4A-4B further include the steps S71-S75. The control method of steps S51-S54 please refer to FIG. 3, and thus the details thereof are omitted for brevity.

In step S71, the control unit 12 determines whether a record rule supports the first application according to the first related data. When the record rule supports the first application, the process goes to step S72. When the record rule does not support the first application, the process goes to step S53. For example, the record rule records the supported application names, and the control unit 12 determines whether the first application is supported by the record rule according to the application name of the first related data.

In step S72, the control unit 12 obtains the first scenario information of the first application from the storage unit 13 according to the record rule, and the process goes to step S73. For example, when the first application is supported by the record rule, the control unit 12 obtains the scenario information of the first application from the storage unit 13 according to the record rule. For example, when the browser is supported by the record rule, the control unit 12 obtains the first scenario information of the browser at the first time from the first storage unit 13. In the present embodiment, the first scenario information includes the browsed website and the page name, but it is not limited thereto. In another embodiment, when the first application is a music player, the first scenario information includes the name and the elapsed time of the played song, but it is not limited thereto. In another embodiment, when the first application is the email software, the first scenario information includes the browsed letters at the first time, but it is not limited thereto.

In the step S73, the control unit 12 displays the text input window on the display 14 for receiving the first memo data, and the process goes to step S74. The step S73 is similar to the step S53 in FIG. 3, and the relevant control method please refer to FIG. 3, and thus the details thereof are omitted for brevity. In the step S74, the control unit 12 links the first memo data to the first related data, and the process goes to step S75. The step S74 is similar to the step S54 in FIG. 3, and the relevant control method please refers to FIG. 3, and thus the details thereof are omitted for brevity. In the step S75, the control unit 12 stores the first record formed by the first image, the first memo data and the first scenario information. The step S75 is similar to the step S62 in FIG. 3, and the difference of the first record of the step S75 is that it further includes the first scenario information. The control method of the step S75 please refer to the step S62 in FIG. 3, and thus the details thereof are omitted for brevity. Furthermore, when the input device receives the second enabling signal at the second time, the control method of the electronic device 10 is similar to the steps S51-S54, S61-S62 and S71-S74 in FIGS. 4A-4B, and thus the details thereof are omitted for brevity.

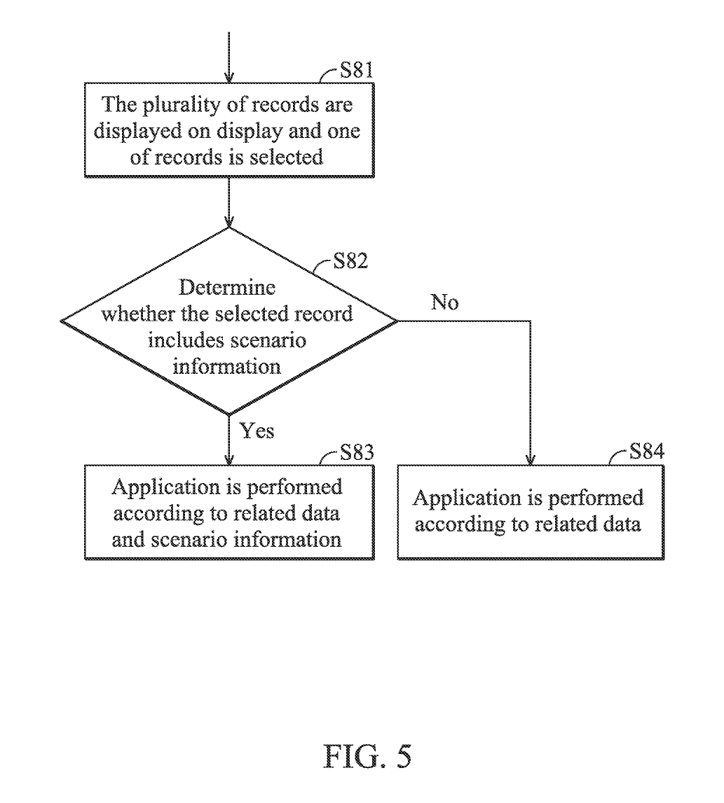

FIG. 5 is another flow chart of the control method according to an embodiment of the present invention. FIG. 5 illustrates how the control unit 12 re-performs the applications performed at a previous time according to a plurality of records (e.g. the first record and/or the second record). In one embodiment, the step S81 in FIG. 5 goes after step S62 in FIG. 3. In another embodiment, the step S81 in FIG. 5 follows the step S62 and the step S75 in FIGS. 4A-4B. The process of FIG. 5 begins at step S81, and the control unit 12 displays the plurality of records on the display 14 for the user to select one of the records, and the process goes to step S82. In this embodiment, the control unit 12 displays the first record and/or other records (e.g. the second record) on the display 14, and the user selects one of the records (e.g. the first or second record) shown on the display 14.

In the step S82, the control unit 12 determines whether the selected record includes the scenario information. When the selected record includes the scenario information, then the process goes to step S83. When the selected record does not include the scenario information, the process goes to step S84.

In step S83, the control unit 12 operates the application according to the related data and the scenario information. For example, the first related data is the application name and the execution path of the browser and the first scenario information is the website address and the page name. When the selected record has the first related data and the first scenario information, the control unit 12 performs the browser program according to the first related data, and then the page of the browser will be restored to the previous page which is the user-viewed page at the first time according to the first scenario information. For example, the first related data comprises the application name and the execution path of the music player as well as the first scenario information comprises the name and the elapsed time of the played song. The control unit 12 operates the music player according to the first related data, and then the song will be restored to the previous song which was played at the first time according to the first scenario information.

In step S84, the control unit 12 performs the application according to the related data. For example, the first related data is the application name and the execution path of the game software. The control unit 12 performs the game software according to the first related data when the selected record had the first related data.

In summary, the electronic device and the control method of the present invention record the control status and/or the control scenario of the different applications at the different time, and through selecting the records recorded at a different time, the used applications and/or the scenario at the certain time can be restored, which brings the user more convenience.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electrical device, comprising:
an input device, configured to receive a first enabling signal at a first time and a second enabling signal at a second time that is different from the first time;
an application recorder, configured to record a plurality of applications which have been performed by the electronic device; and
a control unit, configured to obtain first related data of a first application and link a first memo data input by the user to the first related data at the first time, and to obtain second related data of a second application different from the first application and link a second memo data input by the user to the second related data at the second time, wherein the first application is the last application performed before the first time among the plurality of applications recorded in the application recorder and the second application is the last application performed before the second time among the plurality of applications recorded in the application recorder.

2. The electrical device as claimed in claim 1, wherein the control unit further stores a first image displayed on a display at the first time, and the control unit further stores a second image displayed on the display at the second time, a first record is formed by the first image and the first memo and a second record is formed by the second image and the second memo, and when the control unit displays the first record on the display and the first record is selected, the control unit performs the first application according to the first related data.

3. The electrical device as claimed in claim 1, wherein the first related data comprises an execution path and an application name of the first application, and the second related data comprises an execution path and an application name of the second application.

4. The electrical device as claimed in claim 2, wherein the control unit obtains a first scenario information of the first application at the first time from a storage unit according to the first related data and a record rule, and obtains a second scenario information of the second application at the second time from the storage unit according to the second related data and the record rule, and the control unit performs the first application according to the first related data and the first scenario information when the control unit displays the first record on the display and the first memo data is selected.

5. The electrical device as claimed in claim 4, wherein the first application is a browser, the first scenario information comprises a website address and a page name, the second application is a music player, and the second scenario information comprises a name and an elapsed time of a played song.

6. A control method, suitable for an electrical device, the electronic device having an input device, an application recorder and a control unit, the control method comprising:
reading a first related data of a first application recoded in the application recorder when receiving a first enabling signal from the input device at a first time;
linking a first memo data input by the user to the first related data;
reading a second related data of a second application different from the first application in the application recorder when receiving a second enabling signal from the input device at a second time different from the second time; and
linking a second memo data input by the user to the second related data;
wherein the first application is the last application performed program before the first time recorded in the application recorder and the second application is the last application performed program before the second time recorded in the application recorder.

7. The control method as claimed in claim 6, further comprising:
storing a first image displayed on a display at the first time; and
storing a second image displayed on the display at the second time.

8. The control method as claimed in claim 7, further comprising:
combining the first image and the first memo data to a first record, and the second image and the second memo data to a second record, respectively;
displaying the first record on the display; and
performing the first application according the first related data when the first record is selected.

9. The control method as claimed in claim 6, wherein the first related data comprises an execution path and an application name of the first application and the second related data comprises an execution path and an application name of the second application.

10. The control method as claimed in claim 8, further comprising:
reading a first scenario information of the first application at the first time from a storage unit according to the first related data and a record rule, and a second scenario information of the second application at the second time from the storage unit according to the second related data and the record rule;
displaying the first record on the display; and
performing the first application according to the related data and the first scenario information when the first memo data is selected.

11. The control method as claimed in claim 10, wherein the first application is a browser, the first contextual information comprises a website address and a page name, the second application is a music player, and the second scenario information comprising a name and an elapsed time of a played song.
